(19) United States
(12) Patent Application Publication
(10) Pub. No.: US 2025/0389863 A1
(43) Pub. Date: Dec. 25, 2025

(54) ELECTRONIC PORT LIQUID DETECTION

(71) Applicant: TEXAS INSTRUMENTS INCORPORATED, Dallas, TX (US)

(72) Inventors: Chengxi LIU, Austin, TX (US); Deric Wayne WATERS, Dallas, TX (US); Katherine HUCKABAY, Ooltewah, TN (US)

(21) Appl. No.: 18/750,398

(22) Filed: Jun. 21, 2024

(51) Int. Cl. G01V 3/02

(52) U.S. Cl. CPC G01V 3/02

(57) ABSTRACT

In examples, an electronic device includes a resistor adapted to be coupled to an electronic port pin, and the device includes a current source coupled to the resistor and adapted to be coupled to the electronic port pin. The device includes a switch coupled to the resistor and to the current source, the switch adapted to be coupled to the electronic port pin. The device includes control logic coupled to the switch. The control logic is configured to actuate the switch, monitor a rise in a voltage across the resistor with respect to time after the actuation of the switch, and determine whether liquid is present at the electronic port pin based on the monitoring.

### BACKGROUND

Electronic devices may include electronic ports, such as Universal Serial Bus (USB) ports. Electronic ports are physical interfaces that facilitate the transfer of data and/or power between multiple electronic devices. Such electronic ports may be located on an exterior of the electronic device and may include, facilitating the connection of compatible cables or devices. Electronic ports facilitate data and/or power exchange between the electronic device and peripherals, including storage devices, input devices, and other electronic gadgets, enabling functionalities such as file transfer, device charging, and peripheral connectivity.

### SUMMARY

In examples, an electronic device includes a resistor adapted to be coupled to an electronic port pin, and the device includes a current source coupled to the resistor and adapted to be coupled to the electronic port pin. The device includes a switch coupled to the resistor and to the current source, the switch adapted to be coupled to the electronic port pin. The device includes control logic coupled to the switch. The control logic is configured to actuate the switch, monitor a rise in a voltage across the resistor with respect to time after the actuation of the switch, and determine whether liquid is present at the electronic port pin based on the monitoring. In examples, a method includes modifying a current pathway that is coupled to a current source, a resistor, and an electronic port pin; monitoring, by a control logic, a rise in a voltage across the resistor upon modifying the current pathway; comparing, by the control logic, the rise in the voltage to normative data; and determining, by the control logic, whether liquid is contacting the electronic port pin based on the comparison.

### BRIEF DESCRIPTION OF THE DRAWINGS

FIG. 1 is a block diagram of electronic devices configured to detect liquid in electronic ports, in accordance with various examples.

FIG. 2 is a schematic diagram of an electronic port within which liquid may be detected, in accordance with various examples.

FIG. 3 is a circuit diagram of an electronic port and of electronic port circuitry configured to detect liquid in the electronic port, in accordance with various examples.

FIG. 4 is a block diagram of control logic configured to detect liquid in an electronic port, in accordance with various examples.

FIG. 5 is a flow diagram of a method for detecting liquid in an electronic port, in accordance with various examples.

FIG. 6 is a graph depicting the operational behavior of electronic port circuitry configured to detect liquid in an electronic port, in accordance with various examples.

FIG. 7 is a flow diagram of a method for detecting liquid in an electronic port, in accordance with various examples.

FIG. 8 is a graph depicting the operational behavior of electronic port circuitry configured to detect liquid in an electronic port, in accordance with various examples.

### DETAILED DESCRIPTION

As described above, electronic devices may include electronic ports to provide and receive data and/or power. For instance, two electronic devices may be connected to each other by a USB cable, with one end of the USB cable coupled to a USB port in one of the two devices and an opposite end of the USB cable coupled to a different USB port in the other of the two devices. Through the USB cable, the two electronic devices may exchange data and power.

Electronic ports may include multiple metal pins. These metal pins contact other metal pins, such as the metal pins in a cable, to facilitate the exchange of data and/or power. The presence of multiple metal pins in an enclosed space such as an electronic port presents risks to the operational integrity of the electronic port, and more generally, to the operational integrity of the device within which the electronic port is included. For example, if an electronic device user spills a liquid (e.g., coffee, tea, energy drink, soda) on their desk, that liquid may enter the electronic port of the device. The liquid may be conductive and thus may introduce problems such as electrical shorts and corrosion. For example, if liquid is present between two metal pins with a large enough voltage difference to cause current to flow from one pin to the other through the liquid, corrosion can occur.

This disclosure describes various examples of devices and methods that facilitate the rapid detection of liquid in electronic ports. In examples, an electronic device includes a resistor configured to be coupled to an electronic port pin (e.g., a metal pin). The device also includes a current source coupled to the resistor and configured to be coupled to the electronic port pin. The device further includes a switch coupled to the resistor and the current source and configured to be coupled to the electronic port pin. The device includes control logic configured to actuate the switch, monitor a rise in a voltage across the resistor with respect to time after the actuation of the switch, and determine whether liquid is present at the electronic port pin based on the monitoring.

The devices and methods described herein provide multiple advantages. For example, when potentially damaging liquids are rapidly identified using such electronic devices, corrective action can be taken immediately, thus mitigating damage to the electronic port and, more generally, to the electronic device in which the electronic port is included. In addition, the technique can be performed very quickly (e.g., under 100 microseconds). Further, the cost to implement the device and to perform the method is relatively low.

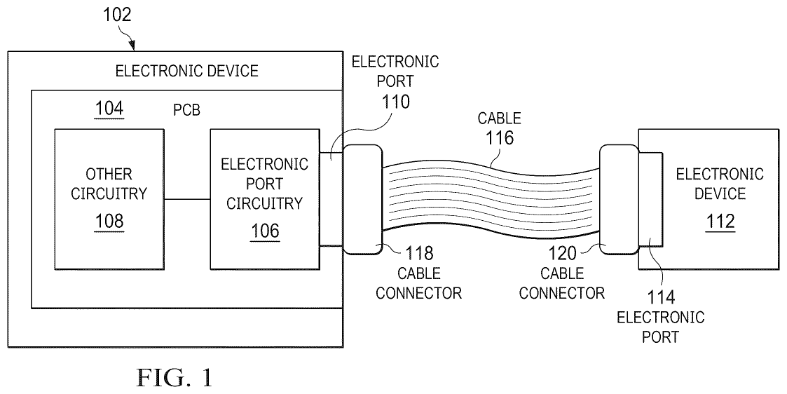

FIG. 1 is a block diagram of electronic devices configured to detect liquid in electronic ports, in accordance with various examples. In particular, FIG. 1 shows an electronic device 102, such as a laptop computer, desktop computer, notebook, tablet, smartphone, external storage devices (e.g., hard drives, solid-state drives), keyboards and mice, printers and scanners, digital cameras, audio devices (e.g., headphones), WiFi and Ethernet adapters, video game controllers, webcams, portable media players, virtual reality headsets, medical devices, sensors, educational tools (e.g., USB microscopes, digital whiteboards), uninterruptible power supplies, smart home devices (e.g., security cameras, lights, and thermostats), 3D printers, portable chargers, etc. The scope of this disclosure is not limited to any particular type of electronic device 102. The electronic device 102 may include a printed circuit board (PCB) 104. Electronic port circuitry 106 may be coupled to the PCB 104. Other circuitry 108 (e.g., processors (e.g., microcontrollers), memory (e.g., random access memory, read only memory), various integrated circuits) and an electronic port 110 also may be coupled to the PCB 104. Each of the other circuitry 108 and the electronic port 110 may be coupled to the electronic port circuitry 106. In examples, the electronic port 110 is a USB port, such as a USB-A port, a USB-B port, a USB-C port, a micro USB port, a mini USB port, etc. The scope of this disclosure is not limited to any particular type of USB port, nor is the scope of this disclosure limited to any particular type of electronic port 110. Non-USB ports also may be used as the electronic port 110 (e.g., Ethernet, High-Definition Multimedia Interface, DisplayPort). Regardless of the specific type of electronic port 110, the electronic port circuitry 106 and the other circuitry 108 are compatible with that type of electronic port 110.

FIG. 1 further depicts another electronic device 112. The electronic device 112 may include a laptop computer, desktop computer, notebook, tablet, smartphone, a hub, a USB charger, keyboards, mice, printers, scanners, webcams, microphones, speakers, medical devices, etc. The scope of this disclosure is not limited to any particular type of electronic device 112. The electronic device 112 may include an electronic port 114, similar to and compatible with the electronic port 110, described above. The electronic device 112 may further include various components similar to those shown within the electronic device 102, such as the PCB 104, electronic port circuitry 106, and other circuitry 108.

A cable 116 couples the electronic devices 102, 112 to each other. The cable 116 includes cable connectors 118, 120 on opposing ends of the cable 116. The cable connectors 118, 120 are compatible with and can be coupled to the electronic ports 110, 114, respectively. For example, the cable connector 118 operates under the same protocol as the electronic port 110 (e.g., a specific USB protocol) and has a metal pin/contact arrangement that mates with that of the electronic port 110. Similarly, the cable connector 120 operates under the same protocol as the electronic port 114 (e.g., a specific USB protocol) and has a metal pin/contact arrangement that mates with that of the electronic port 114. Through the cable 116, the electronic devices 102, 112 send and/or receive data and/or power. The operation of the electronic device 102 is now described. The operation of the electronic device 112 is similar to that of the electronic device 102 and thus is not described in substantial detail.

During operation, liquid may enter the electronic port 110. The liquid may enter the electronic port 110 while the cable connector 118 is coupled thereto, or while the electronic port 110 is disconnected from any other apparatus. The electronic port circuitry 106 is configured to detect the presence (and, in some examples, the type) of the liquid in the electronic port 110, as described below. The electronic port circuitry 106 may further be configured to provide an alert signal to the other circuitry 108 responsive to liquid being detected, which may notify a user of the electronic device 102 accordingly (e.g., by way of an alert on a display, or an email or other text-based message, or an LED indicator).

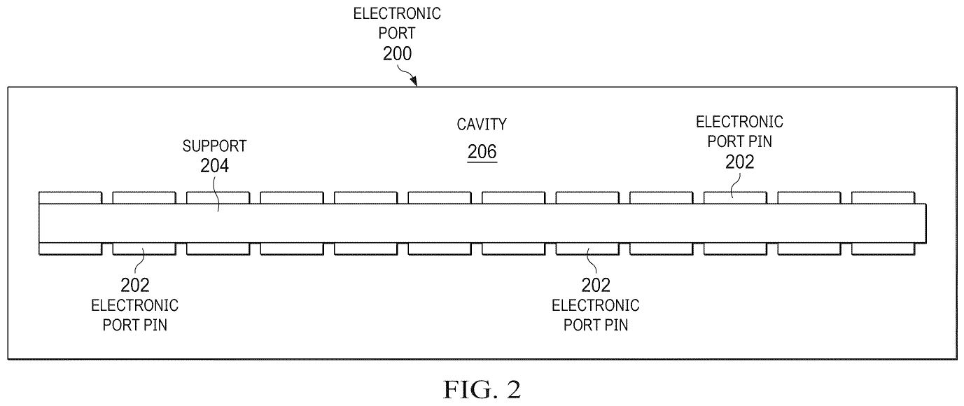

FIG. 2 is a schematic diagram of an electronic port within which liquid may be detected, in accordance with various examples. More particularly, FIG. 2 shows an electronic port 200, which may be an example of the electronic port(s) 110, 114 of FIG. 1. The electronic port 200 may include multiple electronic port pins 202 on a support 204. The support 204 may be suspended inside a cavity 206 of the electronic port 200. The electronic port pins 202 may couple to the electronic port circuitry 106. The electronic port pins 202 may have differing operations. For example, some of the electronic port pins 202 may receive or provide power, while other electronic port pins 202 may receive or provide data. Some electronic port pins 202 may provide power and/or data in different circumstances and in different ways than other electronic port pins 202. The scope of this disclosure is not limited to any particular arrangement, configuration, or operation of the various electronic port pins 202. Responsive to a liquid contacting one or more of the electronic port pins 202, the electronic port circuitry 106 may rapidly detect the presence and, optionally, the type of the liquid in accordance with techniques described herein.

Various electronic port pins 202 may be useful for liquid detection, depending on the communication protocol, the specific application in which the electronic port 200 is deployed, etc. In some examples, one or more of the electronic port pins 202 may be dedicated exclusively to liquid detection according to the techniques described herein. By dedicating one or more electronic port pins 202 to liquid detection, other potential uses of the pin(s) 202, such as data or power transfer, do not require consideration. Thus, testing may be performed at any time without concern for disturbing data and power operations. In other examples, the operation of the pin(s) used for liquid detection may be considered. For instance, in an example in which the electronic port 200 is a USB-C port, 24 pins may be present, with some pins used primarily as ground terminals, some pins used to transfer data, some pins used to transfer power, and some pins used to coordinate communications between the electronic devices that are coupled to each other using the electronic port 200. For example, sideband-use (SBU) pins may be useful for liquid detection if a dedicated pin is unavailable, as SBU pins are high-impedance pins in most cases. The data positive/data negative pins (D+/D−) are primarily used for data transfer and may be useful for liquid detection when data is not actively being transferred. Similarly, configuration channel (CC) pins are primarily used for power delivery negotiation and configuration and may be useful for liquid detection when not actively being used for other purposes. Many such pins besides SBU, D+/D−, and CC pins also may be useful for liquid detection.

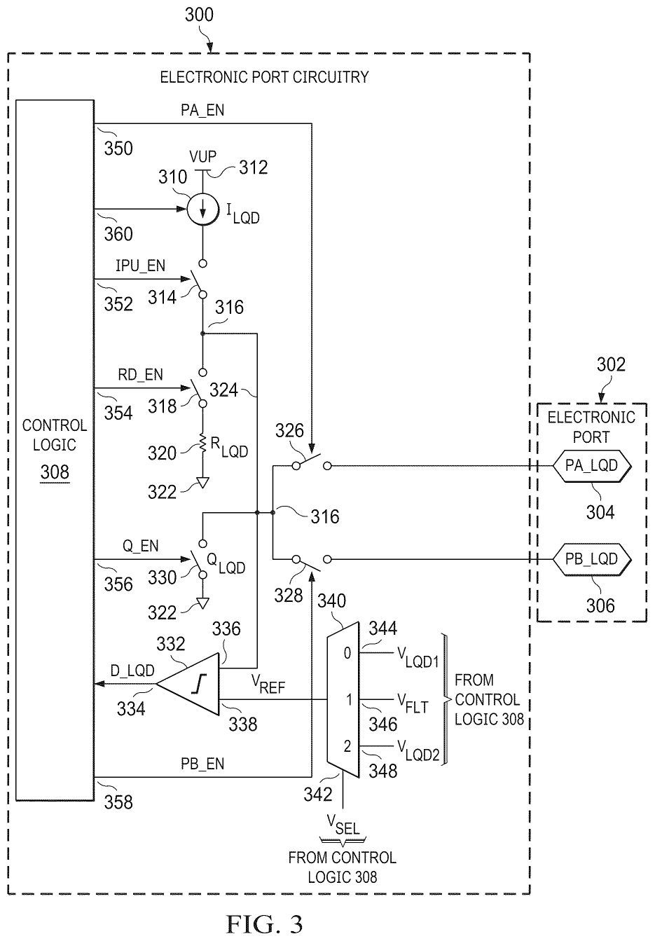

Some pins in an example electronic port 200, such as the SBU, D+/D−, and CC pins, connect through a cable (e.g., a USB-C cable) to another electronic device. For example, if the USB-C protocol were used in the system of FIG. 1, the SBU, D+/D−, and CC pins in the electronic port 110 may couple to corresponding pins in the electronic port 114 through the cable 116. In such cases, it is possible that both of the electronic devices attempt to perform liquid detection operations at the same time. This can cause inaccurate liquid detection results, as the two electronic port circuits in the two electronic devices can apply bias currents or voltages to each other. To mitigate the risk of inaccurate liquid detection results in this situation, a control logic (such as control logic 308 in FIG. 3, described below) may be configured to monitor the voltage on one or more of the CC pins of the electronic port 200 during the liquid detection process. If the CC pin voltage(s) fall within a predetermined range during the liquid detection process, such as a range indicating an active connection through the USB-C cable, it is likely that an electronic device is attached to the electronic device in which the electronic port 200 is included. Thus, after a comparison of the voltage on the CC pin to the predetermined CC pin voltage range, if the CC pin voltage is in the predetermined range during the liquid detection process, the results of the liquid detection operation may be discarded. Alternatively, additional liquid detection operations may be performed, optionally with a pseudo-random delay between each attempt (e.g., 10 microseconds, 25 microseconds, 60 microseconds, 75 microseconds, and 100 microseconds between the consecutive liquid detection operations), to minimize the likelihood that current and/or voltage biases applied by the two electronic devices are interfering with the liquid detection operations. The control logic may use the outcomes of the additional liquid detection operations to determine the state of the electronic port 200. For example, if the majority of the additional liquid detection operations indicate the presence of liquid in the electronic port 200, the control logic may determine that liquid is present in the electronic port 200. Alternatively, if all of the additional liquid detection operations indicate the absence of liquid in the electronic port 200, the control logic may determine that the electronic port 200 is in a dry state. Any and all such permutations are contemplated and included in the scope of this disclosure.

In some examples, the two electronic devices that are coupled to each other may coordinate liquid detection operations to avoid the risks described above. For example, because a sink electronic device (e.g., the electronic device receiving power from a source electronic device) is not at risk of corrosion when unattached to the source electronic device due to a lack of voltage biasing in the cable connector, the source electronic device performs its liquid detection operation first prior to applying a voltage on the VBUS pin. After the source electronic device has completed its liquid detection operation, the source electronic device applies a voltage to the VBUS pin, thus indicating to the sink electronic device that the sink electronic device may begin its liquid detection operation.

In some examples, if a VBUS or other pin is not used to coordinate respective liquid detection operations, the electronic devices may perform their respective liquid detection operations quickly and with long gaps in between consecutive liquid detection operations, thus reducing the likelihood that the two devices will simultaneously attempt to perform liquid detection operations.

The use of CC pins for liquid detection in the USB context may present additional challenges. For example, when some USB cables (e.g., E-Mark cables) are coupled to the electronic port 200, one of the CC pins may experience a significant rise in capacitance, which, for reasons described below, the control logic may interpret to signify the presence of fluid in the electronic port 200. This rise in capacitance from such USB cables is a false positive liquid detection test result. Consequently, it may be useful to perform additional testing to rule out false positive results when using CC pins for liquid detection. To perform this additional testing, the control logic waits until the CC pins reach a direct current (DC) voltage and then determines an impedance at each of the CC pins by comparing the voltage at that CC pin to a specific, predetermined threshold voltage (e.g., a threshold voltage that is less than a threshold voltage used to detect the aforementioned rise in capacitance at the CC pin using the electronic port circuitry as described below). If either CC pin fails to reach that specific, predetermined threshold voltage within a specified amount of time (e.g., 1 millisecond), the liquid detection results described above may indeed be a false positive caused by a USB cable connection and may be discarded. Further, when no USB cable is coupled to the electronic port 200, the control logic may take corrosion mitigation measures (e.g., generating an alert signal) responsive to detection of liquid at both CC pins. However, when a USB cable is coupled to the electronic port 200, the control logic may use one of the CC pins for liquid detection, as the other CC pin may be used for USB communications via the USB cable. In such cases, the control logic may take corrosion mitigation measures (e.g., generating an alert signal) after liquid is detected on multiple (e.g., four) consecutive liquid detection tests. The consecutive liquid detection tests may be administered at regular or irregular intervals.

Various connections states may be possible with respect to the CC pins, as Table 1 describes:

TABLE 1

| | | | CC1 - Liquid | CC2 - Liquid |
|---|---|---|---|---|
| | | | detectable/as | detectable/as |
| | | | source/as | source/as |
| CC1 | CC2 | Connection State | sink/capacitance | sink/capacitance |
| Open | Open | Nothing attached | Y/H/L/600 pF | Y/H/L/600 pF |
| Rd | Open | Sink attached | N/M/L/2 nF | Y/H/L/600 pF |
| Open | Rd | Sink attached | Y/H/L/600 pF | N/M/L/2 nF |
| Rp | Open | Source attached | N/M/L/2 nF | Y/H/L/600 pF |
| Open | Rp | Source attached | Y/H/L/600 pF | N/M/L/2 nF |
| Ra | Open | Active cable, no | N/L/L/10 uF | Y/H/L/600 pF |
| | | sink attached | | |
| Open | Ra | Active cable, no | Y/H/L/600 pF | N/L/L/10 uF |
| | | sink attached | | |
| Ra | Rd | Active cable and | N/L/L/10 uF | N/M/L/2 nF |
| | | sink | | |
| Rd | Ra | Active cable and | N/M/L/2 nF | N/L/L/10 uF |
| | | sink | | |
| Rd | Rd | Debug accessory | N/M/L/? | N/M/L/? |
| | | attached | | |
| Ra | Ra | Deprecated mode | N/L/L/? | N/L/L/? |

The CC1 and CC2 columns denote the specific resistances applied at the CC1 and CC2 pins to signal different types of connections and roles. The CC1 and CC2 pins may be open, have a resistance Ra present on the pin, a resistance Rd on the pin, or a resistance Rp on the pin. A resistance Ra on the pin indicates the presence of an accessory device or an E-Marker or other active circuitry; a resistance Rd on the pin indicates that the device is to operate as a sink (receive power); and a resistance Rp on the pin indicates that the device is to operate as a source (provide power). A device that detects liquid may present Ra. In examples, Rp may be a resistive pullup or a current source pullup. The connection state may be “nothing attached,” meaning no devices are attached via a cable to the CC1 and CC2 pins; “sink attached,” meaning that the connected device is to operate as a sink; “source attached,” meaning that the connected device is to operate as a source; “active cable, no sink attached,” meaning the device is coupled to an active cable but no sink is attached; “active cable and sink,” meaning the device is coupled to an active cable and a sink is attached; “debug accessory attached,” meaning the device is coupled directly to a debug accessory (e.g., no cable); and “deprecated mode,” meaning that the device is coupled to an analog audio accessory. The fourth column indicates, for pin CC1, whether liquid is detectable (“Y” for yes, “N” for no); the voltage that the pin is pulled to while advertising as a source; the voltage that the pin is pulled to while advertising as a sink; and the maximum expected capacitance. In examples, the pin may be pulled to its highest voltage, indicate by “H” (indicates a source advertising Rp); the pin may be pulled to its lowest voltage, indicated by “L” (indicates a sink advertising Rd or device connected to Ra); or the pin may be pulled to a medium voltage indicated by “M” due to an Rp/Rd (source/sink) connection across a cable. Thus, for example, an unconnected source advertises Rp and would be pulled high while an unconnected sink advertises Rd and would be pulled low. The fifth and final column indicates the same information for pin CC2 as the fourth column indicates for pin CC1. Question marks in the fourth and fifth columns indicate presently unknown values

FIG. 3 is a circuit diagram of an electronic port and of electronic port circuitry configured to detect liquid in the electronic port, in accordance with various examples. More specifically, FIG. 3 shows electronic port circuitry 300, which is an example of the electronic port circuitry 106 (FIG. 1). FIG. 3 also shows an electronic port 302, which is an example of the electronic port(s) 110, 114 (FIG. 1) and/or 200 (FIG. 2). The electronic port circuitry 300 is coupled to the electronic port 302. In examples, the electronic port 302 may include an electronic port pin 304 and an electronic port pin 306, which may in some examples be located in separate electronic ports. The electronic port pins 304, 306 are representative of the electronic port pins 202 (FIG. 2) and may be positioned on the same or different sides of the support 204. Although each of the electronic port pins 304, 306 is intended to represent a single physical pin, in some examples, one or more of the electronic port pins 304, 306 represents multiple physical pins. In examples, the electronic port circuitry 300 may include control logic 308, a current source 310 (e.g., providing 0.1 milli amps to 1 milli amps), a voltage supply 312 (VUP) coupled to the current source 310 and configured to provide voltage with which the current source 310 generates current, a switch 314 (e.g., a transistor, such as a bipolar junction transistor (BJT) or field effect transistor (FET) such as a metal oxide semiconductor FET (MOSFET)) coupled to the current source 310, and a node 316 coupled to the switch 314. In examples, the electronic port circuitry 300 may include a switch 318 coupled to the node 316, a resistor 320 (e.g., ranging from 5 kilo ohms to 25 kilo ohms) coupled to the switch 318, and a ground terminal 322 coupled to the resistor 320. The resistor 320 is optional, but is useful to limit the voltage at node 316.

Still referring to FIG. 3, in examples, the electronic port circuitry 300 may include a switch 326 coupled to the node 316 and to the electronic port pin 304. The electronic port circuitry 300 also may include a switch 328 coupled to the node 316 and to the electronic port pin 306. A switch 330 is coupled, for example directly coupled, to the ground terminal 322 and, when closed, may couple the node 316 to the ground terminal 322. A comparator 332 includes a comparator output 334 and comparator inputs 336, 338. The comparator input 336 may be coupled to the node 316, and the comparator input 338 may be coupled to a multiplexer 340. The comparator output 334 may be coupled to the control logic 308. The multiplexer 340 includes a control input 342 (VSEL) and inputs 344 (V_{LQD1}), 346 (V_{FLT}), and 348 (V_{LQD2}). The signals V_{SEL}, V_{LQD1}, V_{ELT}, and V_{LQD2} may be provided by the control logic 308 or by any other suitable source. The multiplexer 340 provides an output reference voltage VREF on the comparator input 338. A conductive member 324 forms at least part of the node 316 and may couple to the switches 314, 318, to the switches 326, 328, and 330, and to the comparator input 336. A “current pathway,” as the term is used herein, refers to the conductive member 324, the switches 314, 318, 326, 328, and 330, the resistor 320, and the ground terminal 322.

In examples, the control logic 308 provides control signals PA_EN, IPU_EN, RD_EN, Q_EN, D_LQD, and PB_EN on control outputs 350, 352, 354, 356, and 358, respectively, which control switches 326, 314, 318, 330, and 328, respectively. For example, the control outputs 350, 352, 354, 356, and/or 358 may be coupled to gate terminals of FET control switches 326, 314, 318, 330, and 328, respectively. A control output 360 controls operation of the current source 310. The operation of the electronic port circuitry 300 is described below.

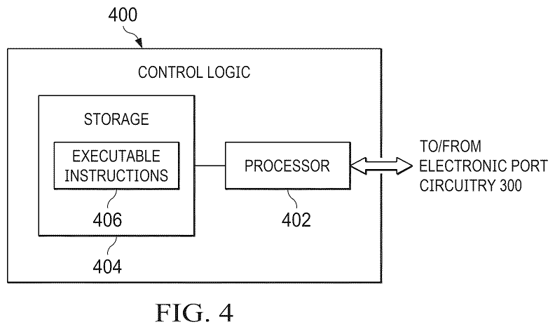

FIG. 4 is a block diagram of control logic configured to detect liquid in an electronic port, in accordance with various examples. In particular, FIG. 4 shows control logic 400, which may be an example of control logic 308 (FIG. 3), including a processor 402 coupled to storage 404 (e.g., random access memory, read only memory). Storage 404 may include executable instructions 406. The processor 402 may execute the executable instructions 406, which causes the processor 402 to perform some or all of the actions attributed herein to the control logic 400, such as the control logic 308. In some examples, the control logic 400, such as the control logic 308, includes analog and/or digital circuitry configured to perform some or all of the actions attributed herein to the control logic 400.

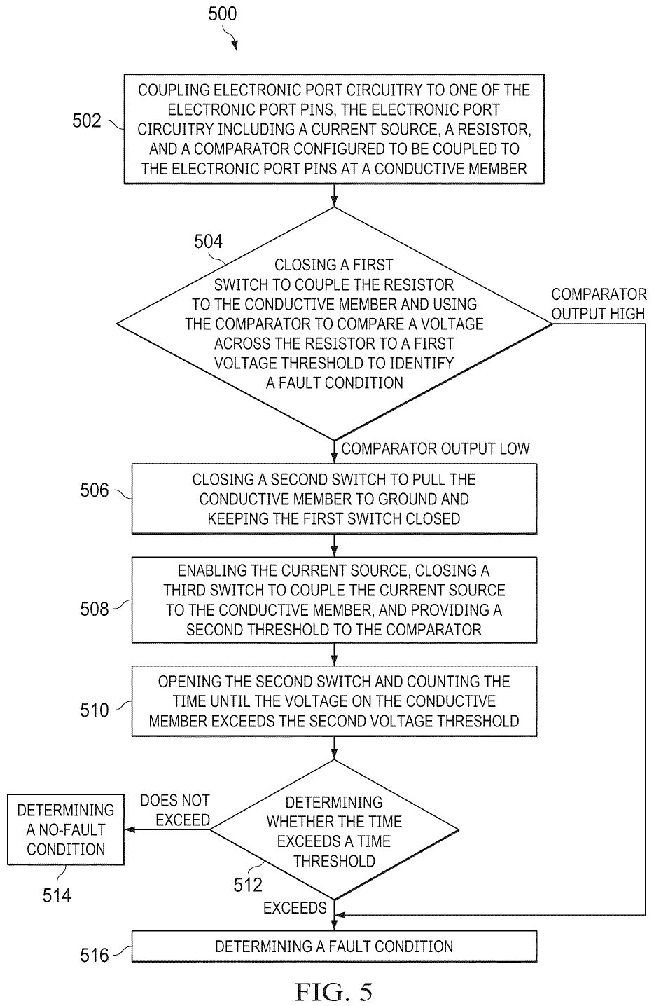

FIG. 5 is a flow diagram of a method for detecting liquid in an electronic port, in accordance with various examples. In particular, FIG. 5 shows a method 500 describing the operation of the electronic port circuitry 300 and the electronic port 302 (FIG. 3). Accordingly, FIGS. 3 and 5 are now described in parallel.

The method 500 includes coupling electronic port circuitry to one of the electronic port pins, the electronic port circuitry including a current source, a resistor, and a comparator configured to be coupled to the electronic port pins at a conductive member (502). In FIG. 3, the electronic port circuitry 300 includes the current source 310, the resistor 320, and the comparator 332. The electronic port circuitry 300 may be coupled to one of the electronic port pins 304, 306 by closing one of the switches 326, 328. For example, the control logic 308 may provide a high signal PA_EN on control output 350 and a low signal PB_EN on control output 358. The remainder of this description assumes the electronic port pin 304 is being tested for the presence of liquid and the electronic port pin 306 is not being tested for the presence of liquid, so step 502 may include closing the switch 326 and opening the switch 328.

The method 500 includes closing a first switch to couple the resistor to the conductive member and using the comparator to compare a voltage across the resistor to a first voltage threshold to identify a fault condition (504). In FIG. 3, the control logic 308 may provide a high signal RD_EN on control output 354 to close the switch 318, thereby coupling the resistor 320 to the conductive member 324. In this way, the voltage at node 316, which is the voltage across the resistor 320, is provided on the comparator input 336. Further, the control logic 308 may provide voltage signals V_{LQD1}, V_{ELT}, and V_{LQD2} on the multiplexer inputs 344, 346, and 348, respectively, and may provide the signal V_{SEL} that causes V_{ELT} to be output by the multiplexer 340 as VREF on the comparator input 338. If the control logic 308 determines that the comparator output 334 has a signal D_LQD that is high, the voltage at the node 316 is greater than V_{ELT}, meaning that there is a fault condition in the electronic port 302 (e.g., whether due to a liquid or any other fault condition). Accordingly, the method 500 includes determining that a fault condition exists (516). Otherwise, the signal D_LQD on the comparator output 334 is low, and the method 500 continues with step 504.

The method 500 includes closing a second switch to pull the conductive member to ground and keeping the first switch closed (506). In FIG. 3, the control logic 308 may issue a high signal Q_EN on control output 356, thus causing the switch 330 to close and pulling the node 316 and the conductive member 324 down to ground. Further, the control logic 308 may maintain a high signal RD_EN on control output 354 to keep the switch 318 closed, thus keeping node 316 pulled down to ground by way of the resistor 320. Accordingly, the resistor 320 is in parallel with the switch 330, and because switch 330 is closed, the resistor 320 is shorted.

The method 500 includes enabling the current source, closing a third switch to couple the current source to the conductive member, and providing a second threshold to the comparator (508). In FIG. 3, the control logic 308 may use the control output 360 to control the current source 310, e.g., to turn on the current source 310. Further, the control logic 308 may provide a high signal IPU_EN on control output 352 to close the switch 314, thereby coupling the current source 310 to the node 316 and the conductive member 324. As a result, a current I_{LQD} is provided to the current pathway, defined above. In addition, the control logic 308 may provide an appropriate control signal V_{SEL} on the control input 342 to cause V_{LQD1} to be provided at the multiplexer 340 output and to the comparator input 338, thus serving as a new voltage threshold value VREF.

In summary, when step 508 is complete, the current source 310 may be enabled, the switch 314 may be closed to enable I_{LQD} to flow to the current pathway defined above, switch 318 may be closed so the resistor 320 is coupled to the node 316, and the switch 330 may be closed so as to short the resistor 320. Further, the switch 326 may be closed to couple the electronic port pin 304 to the node 316, and the switch 328 may be open so the electronic port pin 306 is not coupled to the node 316. The comparator 332 may be comparing the voltage on node 316 (i.e., the voltage across the resistor 320, which is presently 0 V, because the resistor 320 is being shorted) to the present value of V_{REF} on comparator input 338, which may be V_{LQD1}. In examples, V_{LQD1} is selected using experimental or simulation data to reliably distinguish between liquid and dry states in electronic ports, such as the electronic port 302.

The method 500 includes opening the second switch and counting the time until the voltage on the conductive member exceeds the second voltage threshold (510). In FIG. 3, the control logic 308 may provide a low signal Q_EN on control output 356, thereby causing the switch 330 to open. As a result, the node 316 is no longer pulled down to ground through the switch 330, and the resistor 320 is no longer shorted by the switch 330. Consequently, the voltage across the resistor 320, and thus the voltage at node 316, begins to rise as I_{LQD} flows through the resistor 320. The speed at which the voltage across the resistor 320 rises depends on the amount of current flowing through the resistor 320. According to Ohm's law, the higher the current flowing through the resistor 320, the higher the voltage across the resistor 320. If, however, a portion of I_{LQD} is diverted away from the resistor 320, then the current flowing through the resistor 320 will be less, and the voltage across the resistor 320 will rise more slowly. Such a diversion of I_{LQD} may happen if liquid is contacting the electronic port pin 304, thus creating a pathway for at least some of I_{LQD} to flow through the conductive member 324, the switch 326, and to the electronic port pin 304 and the liquid contacting the electronic port pin 304. Thus, if liquid is present in the electronic port 302 and contacting the electronic port pin 304, a portion of I_{LQD} is diverted away from the resistor 320 and to the electronic port pin 304, causing the voltage across the resistor 320 to rise more slowly than it would if I_{LQD} were not being diverted away from the resistor 320 through the electronic port pin 304, because of the greater capacitance present at the electronic port pin 304 in the liquid state compared to the lower capacitance present at the electronic port pin 304 in the dry state. The greater capacitance at the electronic port pin 304 in the liquid state causes current to be diverted away from the resistor 320 for a longer period of time than is the case in the dry state, thus causing the voltage across the resistor 320 to rise more slowly than would be the case in the dry state. As the voltage across the capacitance rises, less current flows to the electronic port pin 304, and more current flows to the resistor 320.

The control logic 308 may measure (e.g., using a clock, such as a clock internal to the control logic 308 and configured to oscillate at approximately 12 MHz) how long the voltage across the resistor 320 takes to rise to a threshold voltage V_{REF} on comparator input 338 by monitoring the comparator output 334 signal D_LQD. More specifically, the control logic 308 begins measuring this time period when the switch 330 is opened, and stops measuring this time period when D_LQD rises from low to high, meaning that the voltage across resistor 320 has exceeded V_{REF}.

The method 500 includes determining whether the measured time exceeds a time threshold (512). For example, in FIG. 3, the control logic 308 may compare the time period measured in step 510 to a programmed time threshold to determine if the voltage across the resistor 320 rose fast enough to indicate a lack of substantial current diversion away from the resistor 320 (a dry state in the electronic port 302) or if the voltage across the resistor 320 rose too slowly, thus indicating substantial current diversion away from the resistor 320 (a liquid state in the electronic port 302). Accordingly, if the measured time exceeds the time threshold, a fault condition is identified (516), and if the measured time does not exceed the time threshold (e.g., is equal to or less than the time threshold), a no-fault condition is determined (514). The time threshold may be programmed in the control logic 308 by any suitable entity, such as a manufacturer or a user. One exception to the above-described behavior of the voltage across the resistor 320 in dry and liquid states is if the liquid is a purely resistive liquid. In that instance, the voltage across the resistor 320 will rise quickly to its maximum value. This maximum voltage is based on the resistance of the liquid, because the presence of the liquid at the electronic port pin 304 causes the capacitance at the electronic port pin 304 to rise relative to the lower capacitance at the electronic port pin 304 in a dry state. Consequently, more current is diverted to the electronic port pin 304 in a liquid state than in a dry state, thus accounting for the slower rise in voltage across the resistor 320 in a liquid state than in a dry state. As the voltage across the capacitance rises, less current flows to the electronic port pin 304, and more current flows to the resistor 320. Thus, the maximum voltage across the resistor 320 is determined by the resistance of the liquid, and time to reach that voltage is determined by the resistor-capacitor (RC) time constant of that particular liquid.

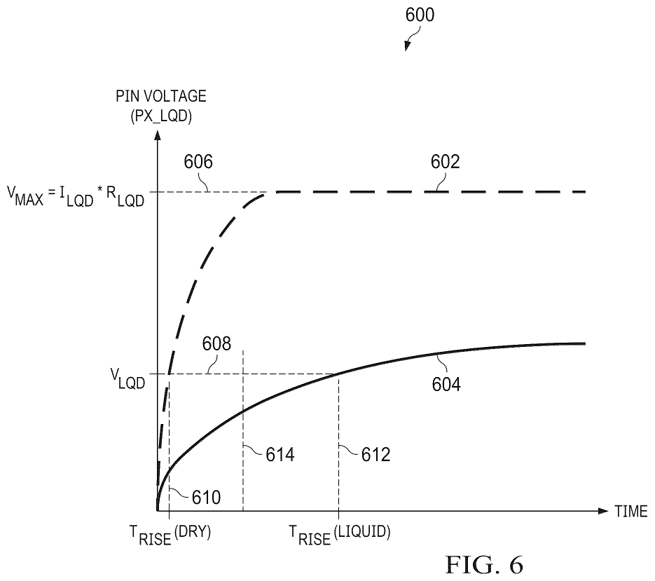

Turn briefly to FIG. 6, which is a graph 600 depicting the operational behavior of the electronic port circuitry 300 (FIG. 3). More specifically, the graph 600 shows time on the x-axis and voltage on the y-axis. A curve 602 depicts the rise in voltage across the resistor 320 when the electronic port 302 (FIG. 3) is in a dry state. Because all or nearly all of I_{LQD} is flowing through the resistor 320, the voltage across the resistor 320 rises quickly, reaching a maximum level 606 defined by the product of I_{LQD} and the resistance of the resistor 320. The curve 602 crosses a threshold 608 (e.g., V_{LQD1} or V_{LQD2}, more generally referred to herein as V_{LQD}) at time 610. Conversely, a curve 604 depicts the rise in voltage across the resistor 320 when the electronic port 302 contains liquid. Because at least some of I_{LQD} is diverted away from the resistor 320 and to the liquid in the electronic port 302, the curve 604 rises more slowly, crossing the threshold 608 at a later time 612 than the time 610. By comparing times 610, 612 to a time threshold 614, the control logic 308 may determine that the time 610 is less than the time threshold 614 and thus the curve 602 likely indicates a dry state in the electronic port 302, while the time 612 is greater than the time threshold 614 and thus the curve 604 likely indicates a liquid state in the electronic port 302.

The threshold 608 may be selected by a user or programmed into the control logic 308 by a manufacturer. The threshold 608 may be chosen to accomplish a variety of objectives. For example, a higher threshold 608 may be chosen to minimize detection errors, meaning that corrosive liquids will be accurately identified as such and non-corrosive liquids or dry states will also be accurately identified as such. Conversely, a lower threshold 608 may be chosen to shorten the detection process, as the curves will cross the threshold 608 more quickly.

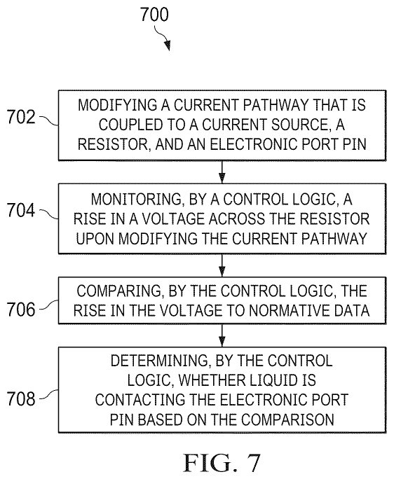

FIG. 7 is a flow diagram of a method 700 for detecting liquid in an electronic port, in accordance with various examples. The method 700 includes modifying a current pathway that is coupled to a current source, a resistor, and an electronic port pin (702). The current pathway in the electronic port circuitry 300, as defined above, is modified by opening and/or closing appropriate switches to prepare for the time measurement operation described above. For example, step 702 may include steps 502, 504, 506, and 508 in FIG. 5. The method 700 includes monitoring, by control logic, a rise in a voltage across the resistor upon modifying the current pathway (704). As described above, the control logic 308 may measure the rise time of the voltage across the resistor 320. In examples, the step 704 may include step 510 (FIG. 5). The method 700 includes comparing, by the control logic, the rise in the voltage to normative data (706). As described above, the control logic 308 may compare the rise time of the voltage across the resistor 320 to a time threshold, such as time threshold 614 (FIGS. 3 and 7), which may reflect normative data derived from experimental and/or simulation testing. Step 706 may include step 512 (FIG. 5). The method 700 includes determining, by the control logic, whether liquid is contacting the electronic port pin based on the comparison of step 706 (708). As described above, the control logic 308 may determine that the measured time either does not exceed (514) or exceeds (516) the time threshold (FIG. 5). Based on the outcome of step 708, the control logic 308 may perform additional operations, such as generating an alert indicating a fault or no-fault condition in the electronic port 302.

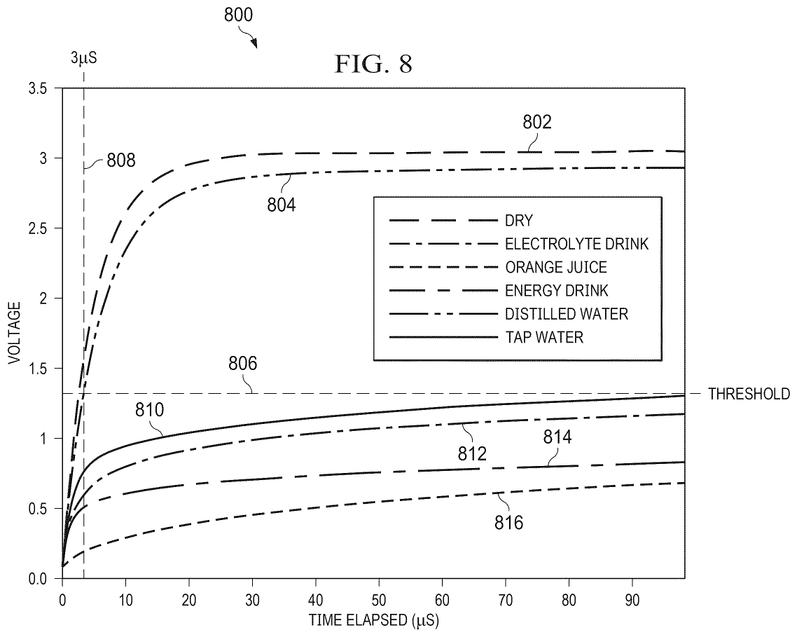

FIG. 8 is a graph 800 depicting the operational behavior of electronic port circuitry configured to detect liquid in an electronic port, in accordance with various examples. More specifically, the graph 800 includes multiple curves 802, 804, 810, 812, 814, and 816, each of which indicates the voltage rise across the resistor 320 over time when in a dry state (curve 802), when a liquid such as distilled water is present in the electronic port 302 (curve 804), when a liquid such as tap water is present in the electronic port 302 (curve 810), when a liquid such as an electrolyte drink is present in the electronic port 302 (curve 812), when a liquid such as an energy drink is present in the electronic port 302 (curve 814), and when a liquid such as orange juice is present in the electronic port 302 (curve 816). The voltages across the resistor 320 rise quickly in the dry state (curve 802) and in the presence of distilled water (curve 804) and rise slowly in the presence of the remaining liquids (curves 810, 812, 814, and 816). In particular, curves 802, 804 cross a voltage threshold 806 at approximately time 808 (e.g., 3 microseconds), while the remaining curves do not cross the voltage threshold by the 100 microsecond mark. The control logic 308 may compare the time 808 to a time threshold (e.g., 10 microseconds, 30 microseconds, 50 microseconds, 75 microseconds, 95 microseconds, or any other suitable cutoff, with the understanding that lower time thresholds maximize testing sensitivity and higher time thresholds maximize testing specificity) and determine that the electronic port 302 is in a dry state, or at least in a non-corrosive liquid state (as distilled water is not a corrosive threat), based on the comparison, or else determine that the electronic port 302 is in a liquid, corrosive state based on the comparison. Additional cutoffs may be implemented to distinguish between states on a more granular level, for example, to distinguish between a dry state and the presence of distilled water, or to distinguish between the types of different liquids corresponding to the curves 810, 812, 814, and 816.

The examples described herein present numerous advantages over other technology for liquid detection. The complexity of the examples described herein is low relative to other solutions, and thus the examples can be implemented with minimal labor, materials, and cost investments. As demonstrated with reference to FIGS. 6 and 8, the presence of liquid can be detected very quickly by the example circuitry shown in FIG. 3, for example in less than 100 microseconds, thereby mitigating the risk of damage caused by the liquid. Further still, as FIG. 8 depicts, the examples described herein are configured to identify whether a detected liquid is corrosive or non-corrosive and may take remedial action accordingly, such as by deciding to generate an alert or a particular type of alert responsive to the detection of corrosive liquid, and by deciding to generate no alert or a lower-priority alert responsive to the detection of non-corrosive liquid. Further yet, the use of a current source 310 in FIG. 3 in lieu of a voltage source is advantageous if there is a resistor divider coupled to ground, at least because the voltage provided may depend at least in part on whether a liquid is present in the electronic port and the type of liquid present in the electronic port, as different liquids have different resistances that they may contribute to the total resistance seen by the voltage supply. Small leakages from other pins in the electronic port may also distort the voltage at the pin being tested. In contrast, a strong current source 310 mitigates these challenges and can lead to more accurate liquid detection results.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be coupled to at least some of the passive elements and/or the sources to form the described structure either at a time of manufacture or after a time of manufacture, for example, by an end-user and/or a third-party.

While certain components may be described herein as being of a particular process technology, these components may be exchanged for components of other process technologies. Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the term “ground terminal” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter. Modifications are possible in the described examples, and other examples are possible within the scope of the claims.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device, or a semiconductor component. Furthermore, a voltage rail or more simply a “rail,” may also be referred to as a voltage terminal and may generally mean a common node or set of coupled nodes in a circuit at the same potential.

What is claimed is:

1. An electronic device, comprising:
a resistor adapted to be coupled to an electronic port pin;
a current source coupled to the resistor and adapted to be coupled to the electronic port pin;
a switch coupled to the resistor and to the current source, the switch adapted to be coupled to the electronic port pin; and
control logic coupled to the switch, the control logic configured to:
actuate the switch;
monitor a rise in a voltage across the resistor with respect to time after the actuation of the switch; and
determine whether liquid is present at the electronic port pin based on the monitoring.

2. The electronic device of claim 1, wherein the switch is a first switch and the resistor is coupled between a second switch and a ground terminal, the second switch coupled to the electronic port pin, the resistor, and the current source.

3. The electronic device of claim 1, wherein the switch is coupled directly to a ground terminal.

4. The electronic device of claim 1, further comprising an electronic port including the electronic port pin and coupled to the resistor, wherein the electronic port is a Universal Serial Bus (USB) port.

5. The electronic device of claim 1, further comprising a comparator having a comparator output and first and second comparator inputs, the comparator output coupled to the control logic, the first comparator input coupled to the electronic port pin, the resistor, and the switch, the second comparator input configured to receive a reference voltage.

6. The electronic device of claim 5, wherein, to make the determination, the control logic is configured to measure a time between the actuation of the switch and the voltage reaching the reference voltage.

7. The electronic device of claim 6, wherein the control logic is configured to determine whether the liquid is corrosive based on a comparison of the time to a time threshold.

8. The electronic device of claim 5, wherein the electronic port pin, the switch, the resistor, and the comparator are coupled to each other at a conductive member.

9. An electronic device, comprising:
an electronic port pin;
a resistor coupled to the electronic port pin;
a current source coupled to the resistor and to the electronic port pin, the current source configured to provide a current to the resistor, the current shared between the resistor and the electronic port pin in the presence of liquid at the electronic port pin; and
control logic configured to determine whether the current is being shared between the electronic port pin and the resistor and to identify the presence of the liquid based on the determination.

10. The electronic device of claim 9, further comprising a first switch coupled between the current source and a conductive member and a second switch coupled between the resistor and the conductive member.

11. The electronic device of claim 10, further comprising a third switch coupled to the first and second switches, and to the electronic port pin, the third switch coupled directly to a ground terminal.

12. The electronic device of claim 10, wherein the electronic port pin is a CC pin of a Universal Serial Bus (USB) port, and wherein the control logic is configured to discard results of the determination based on a comparison of a voltage on the CC pin to a CC pin voltage range.

13. The electronic device of claim 9, further comprising a comparator having a comparator output and first and second comparator inputs, the comparator output coupled to the control logic, the first comparator input coupled to the resistor, and the second comparator input configured to receive a threshold voltage.

14. The electronic device of claim 13, wherein the control logic is configured to make the determination based on a time in which a voltage across the resistor rises to the threshold voltage after the current is applied to the resistor.

15. The electronic device of claim 14, wherein the control logic is configured to determine whether the liquid is corrosive by comparing the time to a time threshold.

16. A method, comprising:
modifying a current pathway that is coupled to a current source, a resistor, and an electronic port pin;
monitoring, by a control logic, a rise in a voltage across the resistor upon modifying the current pathway;
comparing, by the control logic, the rise in the voltage to normative data; and
determining, by the control logic, whether liquid is contacting the electronic port pin based on the comparison.

17. The method of claim 16, wherein modifying the current pathway includes opening a switch that is coupled to a ground terminal, to the current source, to the resistor, and to the electronic port pin.

18. The method of claim 17, wherein the switch is coupled in parallel with the resistor, the switch and the resistor both coupled to the ground terminal.

19. The method of claim 16, wherein the monitoring comprises measuring an amount of time that elapses between the modification of the current pathway and the voltage exceeding a threshold voltage.

20. The method of claim 19, wherein the determining comprises comparing the amount of time to a time threshold.
